(19) United States
(12) Patent Application Publication
(10) Pub. No.: US 2024/0082795 A1
(43) Pub. Date: Mar. 14, 2024

(54) Dispensing Machine

(71) Applicant: Engineered Distribution Specialties, LLC, Rogers, MN (US)

(72) Inventors: Jackson J. Striggow, Rogers, MN (US); Mitchell J. Wienke, Rogers, MN (US); Dennis R. Dingmann, Rogers, MN (US); Jeffery A. Striggow, Rogers, MN (US)

(21) Appl. No.: 18/243,342

(22) Filed: Sep. 7, 2023

Related U.S. Application Data
(60) Provisional application No. 63/404,780, filed on Sep. 8, 2022.

(51) Int. Cl. B01F 25/46; B01F 35/21; B01F 35/71

(52) U.S. Cl. CPC B01F 25/46; B01F 35/2112; B01F 35/712; B01F 2101/2805

(57) ABSTRACT

Silicone dispensers are provided that include a first flow path that includes a first mixing tank, a first pump, and a first mix head inlet, and a second flow path that includes a second mixing tank, a second pump, and a second mix head inlet.

### CROSS-REFERENCE TO RELATED APPLICATIONS

This application claims the benefit of priority to U.S. Application No. 63/404,780, filed on Sep. 8, 2022, the contents of which are hereby incorporated by reference.

The present document relates to automation of a dispensing machine such as a silicone dispenser.

### BACKGROUND

Some batteries used in commercial products including electric vehicles include batteries that power the products and vehicles. Some batteries are lithium-ion batteries that can be combined into battery modules that include a plurality of battery packs. Lithium-ion batteries can include a material for encapsulation of the lithium-ion batteries that is potted within/around the batteries.

### SUMMARY

Some embodiments described herein include systems and methods related to dispensing machines such as silicone dispensers. The silicone dispensers, systems, and methods facilitate the processing of silicone that can be used in one or more batteries. For example, the silicone dispensers, systems, and methods facilitate the processing of one or more mixtures of liquids and glass beads. The dispensers, systems, and methods can prevent, resist, or not significantly cause the curing of silicone within the dispensers and systems while processing mixtures of liquids and glass beads.

Some embodiments described herein include a method of operating a silicone dispenser is provided. The method includes providing a first mixture of a first liquid with a first quantity of glass beads in the first liquid; providing a second mixture of a second liquid with a second quantity of glass beads in the second liquid, where the second liquid has a different composition than that of the first liquid; pumping the first mixture via a first positive displacement pump having a first polymer stator; pumping the second mixture via a second positive displacement pump having a second polymer stator; mixing the first mixture with the second mixture to form a third mixture; and dispensing the third mixture.

Implementations may include one or more of the following features. The method where the first and second polymer stators each define an inner surface defining a flow path, where the first and second polymer stators may include a polymer configured to avoid the inhibition or prevention of curing silicone, where the polymer configured to avoid the inhibition or prevention of curing silicone is positioned on at least the inner surface of the first and second polymer stators. The first and second polymer stators each define an inner surface defining a flow path, where the first and second polymer stators may include HNBR, where the HNBR is positioned on at least the inner surface of the first and second polymer stators. The inner surfaces of the first and second stators include no sulfur. A mix head performs the mixing of the first mixture with the second mixture, the mix head includes: a first inlet in communication with the first positive displacement pump; a second inlet in communication with the second positive displacement pump; and a mixing nozzle in fluid communication with the first inlet and the second inlet that is configured to mix the first mixture and the second mixture and outputs the third mixture. The method may include: mixing the first liquid and the first quantity of glass beads in a first tank with a first agitator having one or more blades that extend to within one inch from an internal tank wall of the first tank; and mixing the second liquid and the second quantity of glass beads in a second tank with a second agitator having one or more blades that extend to within one inch from an internal tank wall of the second tank. The first mixture may include platinum. The method may include monitoring a specific gravity of the first mixture and monitoring a specific gravity of the second mixture. The first mixture and the second mixture have a specific gravity between 0.6 and 0.7. The third mixture is a silicone foam. Implementations of the described techniques may include hardware, a method or process, or computer software on a computer-accessible medium.

In an example embodiment, a silicone dispenser includes a first flow path that may include: a first tank for holding a first liquid with a first quantity of glass beads in the first liquid; a first positive displacement pump having a first stator and a first rotor, where the first stator may include a polymer configured to avoid the inhibition or prevention of curing silicone; at least one first hose. The silicone dispenser also includes a second flow path that may include: a second tank for holding a second liquid with a second quantity of glass beads in the second liquid; a second positive displacement pump having a second stator and a second rotor, where the second stator may include the polymer configured to avoid the inhibition or prevention of curing silicone; at least one second hose.

Implementations may include one or more of the following features. The silicone dispenser where the polymer configured to avoid the inhibition or prevention of curing silicone is positioned on at least an inner surface of the first and second polymer stators. Inner surfaces of the first and second stators include no sulfur. The first and second polymer stators each define an inner surface defining a flow path, where the first and second polymer stators may include HNBR, where the HNBR is positioned on at least the inner surface of the first and second polymer stators. The first tank may include an agitator having one or more blades that extend to within one inch from an internal tank wall of the first tank. The second tank may include an agitator having one or more blades that extend to within one inch from an internal tank wall of the second tank. The silicone dispenser may include: a mix head that includes: a first inlet in communication with the first positive displacement pump, a second inlet in communication with the second positive displacement pump, and a mixing nozzle in fluid communication with the first inlet and the second inlet that is configured to mix the first liquid and the second liquid and outputs a material mixture may include the first material and the second material. The mix head includes: a solenoid that has a first valve connected to the first inlet and a second valve connected to the second inlet, the first valve selectively facilitates fluid communication between the first positive displacement pump and the mixing nozzle, the second valve selectively facilitates fluid communication between the second positive displacement pump and the mixing nozzle. The first flow path may include a first level sensor between the first tank and the first positive displacement pump, and the second flow path may include a second level sensor between the second tank and the second positive displacement pump. Implementations of the described techniques may include hardware, a method or process, or computer software on a computer-accessible medium.

In an example embodiment, a system is provided. The system includes a first tank configured for holding a first material may include a first liquid with a first quantity of glass microspheres in the first liquid; a second tank configured for holding a second material may include a second glass microspheres in the second material; a first progressive cavity pump in fluid communication downstream of the first tank, the first progressive cavity pump including a stator may include HNBR material and a rotor; and a second progressive cavity pump in fluid communication downstream of the second tank, the second progressive cavity pump including a second stator may include HNBR material and a second rotor.

In an example embodiment, a method of operating a silicone dispenser is provided. The method includes providing a first mixture of a first liquid with a first quantity of glass beads in the first liquid; providing a second mixture of a second liquid with a second quantity of glass beads in the second liquid, where the second liquid has a different composition than that of the first liquid; operating the silicone dispenser in a first mode to mix the first mixture with the second mixture to form a third mixture and to dispense the third mixture in response to receiving a command to dispense; and operating the silicone dispenser in a second mode when a most recent command to dispense was most recently received in excess of a threshold amount of time, where the second mode may include repeating a cycle of pumping the first and second mixtures for a first recirculation period and then resting pumping of the first and second mixtures for a rest period.

Implementations may include one or more of the following features. The method may include: operating the silicone dispenser in a third mode in response to receiving a command to dispense during the second mode, where in the third mode the silicone dispenser prevents dispensing of the third mixture until the first and second mixtures have been recirculated for a second recirculation period. In the third mode the silicone dispenser prevents dispensing of the third mixture until a specific gravity of the first mixture and a specific gravity of the second mixture are within a target specific gravity range. The target specific gravity range is between 0.6 and 0.7. The rest period is longer than the first recirculation period, and where the first recirculation period is longer than an amount of time required to circulate substantially all of the first and second mixtures located in first and second hoses to flow into first and second tanks, respectively. The resting period is between 15 minutes and 60 minutes, and where the first recirculation period is between 1 minute and 10 minutes. The silicone dispenser prevents operation of first and second dispensing valves when the most recent command to dispense was most recently received in excess of the threshold amount of time. The silicone dispenser may include a first flow path for recirculating the first mixture and a second flow path for recirculating the second mixture, where the first flow path may include a first hose and a first positive displacement pump, where the second flow path may include a second hose and a second positive displacement pump, where the first and second positive displacement pumps are not operated during the resting period. The silicone dispenser may include a mixer, where the first and second flow paths are configured to bypass the mixer during the first recirculation period. The first mixture may include platinum. The method may include monitoring a specific gravity of the first mixture and monitoring a specific gravity of the second mixture. Implementations of the described techniques may include hardware, a method or process, or computer software on a computer-accessible medium.

In an example embodiment, a silicone dispenser is provided. The silicone dispenser includes a first flow path that may include: a first tank for holding a first mixture of a first liquid with a first quantity of glass beads in the first liquid, at least one first hose. The silicone dispenser also includes a second flow path that may include: a second tank for holding a second mixture of a second liquid with a second quantity of glass beads in the second liquid, where the second liquid has a different composition than that of the first liquid; at least one second hose. The silicone dispenser also includes a controller that may include one or more processors and a computer-readable storage medium coupled to the one or more processors having instructions stored thereon which, when executed by the one or more processors, cause the one or more processors to perform operations that may include: operate the silicone dispenser in a first mode to mix the first mixture with the second mixture to form a third mixture and to dispense the third mixture in response to receiving a command to dispense; and operate the silicone dispenser in a second mode when a most recent command to dispense was most recently received in excess of a threshold amount of time, where the second mode may include repeating a cycle of pumping the first and second mixtures for a first recirculation period and then resting pumping of the first and second mixtures for a rest period.

Implementations may include one or more of the following features. The silicone dispenser where: the first flow path includes a first positive displacement pump having a first stator and a first rotor, where the first stator may include a polymer configured to avoid the inhibition or prevention of curing silicone; and the second flow path includes a second positive displacement pump having a second stator and a second rotor, where the second stator may include the polymer configured to avoid the inhibition or prevention of curing silicone. The first and second positive displacement pumps are not operated during the resting period. In the third mode the silicone dispenser prevents dispensing of the third mixture until the first and second mixtures have been recirculated for a second recirculation period. In the third mode the silicone dispenser prevents dispensing of the third mixture until a specific gravity of the first mixture and a specific gravity of the second mixture are within a target specific gravity range. The rest period is longer than the first recirculation period, and where the first recirculation period is longer than an amount of time required to circulate substantially all of the first and second mixtures located in first and second hoses to flow into first and second tanks, respectively. The silicone dispense prevents operation of first and second dispensing valves when the most recent command to dispense was most recently received in excess of the threshold amount of time. The first mixture may include platinum. Implementations of the described techniques may include hardware, a method or process, or computer software on a computer-accessible medium.

In an example embodiment, a system is provided. The system includes a first tank for holding a first mixture of a first liquid with a first quantity of glass beads in the first liquid, the first tank including a first agitator; a second tank for holding a second mixture of a second liquid with a second quantity of glass beads in the second liquid, where the second liquid has a different composition than that of the first liquid, the second tank including a second agitator; a first pump in fluid communication downstream of the first tank; a second pump in fluid communication downstream of the second tank; a mix head that includes: a first inlet in communication with the first pump; a second inlet in communication with the second pump; a first circulation outlet in fluid communication with the first inlet and the first tank; a second circulation outlet in fluid communication with the second inlet and the second tank; an outlet in fluid communication with the first inlet and the second inlet that includes a mixing nozzle that mixes the first liquid and the second liquid and outputs a material mixture may include the first liquid and the second liquid. The system also includes a controller that may include one or more processors and a computer-readable storage medium coupled to the one or more processors having instructions stored thereon which, when executed by the one or more processors, cause the one or more processors to perform operations may include: track an amount of time since a most recent dispensing operation; determine when the amount of time is in excess of a threshold amount of time; actuate a solenoid into a circulation position where to close the outlet and open the first circulation outlet and the second circulation outlet; track a circulation time that the solenoid is in the circulation position; determine when the circulation time is in excess of a circulation threshold; actuate the solenoid to a closed position where the outlet, the first circulation outlet, and the second circulation outlet are closed.

In an example embodiment, a silicone dispenser is provided. The silicone dispenser includes a first flow path that may include: a first tank for holding a first mixture of a first liquid with a first quantity of glass beads in the first liquid; a first pump having a first stator and a first rotor, where the first stator may include a polymer configured to avoid the inhibition or prevention of curing silicone; at least one first hose; a first mass flow meter connected to an outlet of the first pump, the first mass flow meter configured to measure a mass flow rate of the first mixture downstream of the first pump. The silicone dispenser also includes a second flow path that may include: a second tank for holding a second mixture of a second liquid with a second quantity of glass beads in the second liquid; a second pump having a second stator and a second rotor, where the second stator may include the polymer configured to avoid the inhibition or prevention of curing silicone; at least one second hose; and a second mass flow meter connected to an outlet of the second pump, the second mass flow meter configured to measure a mass flow rate of the second mixture downstream of the second pump. The silicone dispenser also includes a controller that may include one or more processors and a computer-readable storage medium coupled to the one or more processors having instructions stored thereon which, when executed by the one or more processors, cause the one or more processors to perform operations may include: monitor a first specific gravity of the first mixture via the first mass flow meter, monitor a second specific gravity of the second mixture via the second mass flow meter, determine if the first specific gravity and the second specific gravity are within a target specific gravity range, and operate the silicone dispenser in a first mode to mix the first mixture with the second mixture to form a third mixture and to dispense the third mixture in response to receiving a command to dispense.

Implementations may include one or more of the following features. The operations may include: operate the silicone dispenser in a second mode when at least one of the first specific gravity and the second specific gravity are outside of the target specific gravity range, where the second mode may include repeating a cycle of pumping the first and second mixtures for a first recirculation period and then resting pumping of the first and second mixtures for a rest period. In the third mode the silicone dispenser prevents dispensing of the third mixture until the specific gravity of the first mixture and the specific gravity of the second mixture are within the target specific gravity range. The target specific gravity range is between 0.6 and 0.7. The silicone dispenser may include: a mix head that includes: a first inlet in communication with the first pump, a second inlet in communication with the second pump, a mixing nozzle in fluid communication with the first inlet and the second inlet that is configured to mix the first mixture and the second mixture and outputs a material mixture may include the first mixture and the second mixture. Colon> the first pump having a first stator and a first rotor, where the first stator may include a polymer configured to avoid the inhibition or prevention of curing silicone; the second pump having a second stator and a second rotor, where the second stator may include the polymer configured to avoid the inhibition or prevention of curing silicone. The first and second polymer stators each define an inner surface defining a flow path, where the first and second polymer stators may include hnbr, where the hnbr is positioned on at least the inner surface of the first and second polymer stators. Inner surfaces of the first and second stators include no sulfur. The first mixture may include platinum. The first flow path may include a first level sensor between the first tank and the first pump, and the second flow path may include a second level sensor between the second tank and the second pump. Implementations of the described techniques may include hardware, a method or process, or computer software on a computer-accessible medium.

In an example embodiment, a method of operating a silicone dispenser is provided. The method includes providing a first mixture of a first liquid with a first quantity of glass beads in the first liquid; providing a second mixture of a second liquid with a second quantity of glass beads in the second liquid, where the second liquid has a different composition than that of the first liquid; monitoring a first specific gravity of the first mixture via a first mass flow meter; monitoring a second specific gravity of a second mixture via a second mass flow meter; determining if the first specific gravity and the second specific gravity are within a target specific gravity range; operating the silicone dispenser in a first mode to mix the first mixture with the second mixture to form a third mixture and to dispense the third mixture in response to receiving a command to dispense; operating the silicone dispenser in a second mode when at least one of the first specific gravity and the second specific gravity are outside of the target specific gravity range, where the second mode may include repeating a cycle of pumping the first and second mixtures for a first recirculation period and then resting pumping of the first and second mixtures for a rest period.

Implementations may include one or more of the following features. The method may include: operating the silicone dispenser in a third mode in response to receiving a command to dispense during the second mode, where in the third mode the silicone dispenser prevents dispensing of the third mixture until the specific gravity of the first mixture and the specific gravity of the second mixture are within the target specific gravity range. The target specific gravity range is between 0.6 and 0.7. The method may include: monitoring a level of the first mixture in a first flow path; monitoring a level of the second mixture in a second flow path. Colon> the first flow path includes a first pump having a first stator and a first rotor, where the first stator may include a polymer configured to avoid the inhibition or prevention of curing silicone; the second flow path includes a second pump having a second stator and a second rotor, where the second stator may include the polymer configured to avoid the inhibition or prevention of curing silicone. The first and second polymer stators each define an inner surface defining a flow path, where the first and second polymer stators may include hnbr, where the hnbr is positioned on at least the inner surface of the first and second polymer stators. Inner surfaces of the first and second stators include no sulfur. The first mixture may include platinum. The first flow meter and the second flow meter are coriolis meters. Implementations of the described techniques may include hardware, a method or process, or computer software on a computer-accessible medium.

In an example embodiment, a system is provided that includes a first tank configured for holding a first material may include a first part addition cure silicone foam and glass microspheres; a second tank configured for holding a second material may include a second part addition cure silicone foam and glass microspheres; a first pump in fluid communication downstream of the first tank; a first mass flow meter connected to an outlet of the first pump, the first mass flow meter configured to measure a mass flow rate of the first material downstream of the first pump; a second pump in fluid communication downstream of the second tank; a second mass flow meter connected to an outlet of the second pump, the second mass flow meter configured to measure a mass flow rate of the second material downstream of the second pump; and a controller may include one or more processors and a computer-readable storage medium coupled to the one or more processors having instructions stored thereon which, when executed by the one or more processors, cause the one or more processors to perform operations may include: monitor the mass flow rate of the first material and the mass flow rate of the second material; determine whether the mass flow rate of the first material and the mass flow rate of the second material are within an acceptable mass flow rate range; operate, based on a determination that the mass flow rate of the first material and the mass flow rate of the second material are within the acceptable range, an outlet valve at a mix head into an open position to dispense a mixture of the first material and the second material; operate, based on the determination that the mass flow rate of the first material and the mass flow rate of the second material are outside of the acceptable range, the outlet valve into a circulation position to recirculate the first material into the first tank and the second material into the second tank before mixing the first material and the second material.

In an example embodiment, a silicone dispenser is provided. The silicone dispenser includes a first flow path may include: a first tank for holding a first liquid with a first quantity of glass beads in the first liquid; a pump having a first stator and a first rotor, where the first stator may include a polymer configured to avoid the inhibition or prevention of curing silicone; a first mix head inlet; at least one first hose that extends from the first pump to the first mix head inlet; where the first flow path between the first pump and the first mix head inlet is free of turns at an angle of 90 degrees or less. The silicone dispenser also includes a second flow path that may include: a second tank for holding a second liquid with a second quantity of glass beads in the second liquid; a second pump having a second stator and a second rotor, where the second stator may include the polymer configured to avoid the inhibition or prevention of curing silicone; a second mix head inlet; at least one second hose that extends from the second pump to the second mix head inlet; where the second flow path between the second pump and the first mix head inlet is free of turns at an angle of 90 degrees or less. The silicone dispenser also includes a third flow path that may include: a mixing nozzle connected to the first mix head inlet and the second mix head inlet, the mixing nozzle is configured to mix the first liquid and the second liquid and output a third material that is a mixture may include the first liquid and the second liquid.

Implementations may include one or more of the following features. The silicone dispenser where a solenoid is positioned in the first flow path and the second flow path, the solenoid including: a first valve connected to the first mix head inlet, the first valve selectively facilitates fluid communication between the first flow path and the third flow path; and a second valve connected to the second inlet, the second valve selectively facilitates fluid communication between the second flow path and the third flow path. Colon> the fourth flow path may include: a first circulation outlet in fluid communication with the first mix head inlet and the first tank, the fourth flow path between the first mix head inlet and the first tank is free of turns at an angle of 90 degrees or less; the fifth flow path may include: a second circulation outlet in fluid communication with the second mix head inlet and the second tank, the fifth flow path between the second mix head inlet and the second tank is free of turns at an angle of 90 degrees or less. A solenoid is positioned in the first flow path and the second flow path, the solenoid including: a first valve connected to the first mix head inlet, the first valve having an open position that facilitates fluid communication between the first flow path and the third flow path, the first valve having a circulation position that facilitates communication between the first flow path and the fourth flow path; and a second valve connected to the second inlet, the second valve having an open position that facilitates fluid communication between the second flow path and the third flow path, the second valve having a circulation position that facilitates communication between the second flow path and the fifth flow path. The first flow path and the second flow path provide a means to reduce shear in the first material and the second material. Colon> the first pump having a first stator and a first rotor, where the first stator may include a polymer configured to avoid the inhibition or prevention of curing silicone; the second pump having a second stator and a second rotor, where the second stator may include the polymer configured to avoid the inhibition or prevention of curing silicone. The first and second polymer stators each define an inner surface defining a flow path, where the first and second polymer stators may include hnbr, where the hnbr is positioned on at least the inner surface of the first and second polymer stators. Inner surfaces of the first and second stators include no sulfur. The first mixture may include platinum. The first flow path may include a first level sensor between the first tank and the first pump, and the second flow path may include a second level sensor between the second tank and the second pump. Implementations of the described techniques may include hardware, a method or process, or computer software on a computer-accessible medium.

In an example embodiment, a method of operating a silicone dispenser is provided. The method includes providing a first mixture of a first liquid with a first quantity of glass beads in the first liquid to a first mix head inlet via a first flow path that is free of turns at an angle of 90 degrees or less; providing a second mixture of a second liquid with a second quantity of glass beads in the second liquid, to a second mix head inlet via a second flow path that is free of turns at an angle of 90 degrees or less; operating a first valve connected to the first mix head inlet, the first valve facilitates fluid communication between the first flow path and a third flow path; operating a second valve connected to the second inlet, the second valve facilitates fluid communication between the second flow path and the third flow path. mixing the first mixture with the second mixture to form a third mixture; and dispensing the third mixture.

Implementations may include one or more of the following features. The method may include: operating the first valve into a circulation position that facilitates fluid communication between the first flow path a fourth flow path, the fourth flow path extends between the first mix head inlet and a first tank. The fourth flow path is free of turns at an angle of 90 degrees or less. The method may include: operating the second valve into a circulation position that facilitates fluid communication between the second flow path a fifth flow path, the fifth flow path extends between the second mix head inlet and a second tank. The fifth flow path is free of turns at an angle of 90 degrees or less. The first valve and the second valve may include a solenoid. The mixing of the first mixture and the second mixture occurs via a mixing nozzle. The method may include: monitoring a level of the first mixture in a first flow path; monitoring a level of the second mixture in a second flow path. The method may include: monitoring a first specific gravity of the first mixture via a first mass flow meter; monitoring a second specific gravity of a second mixture via a second mass flow meter. The first mixture may include platinum. Implementations of the described techniques may include hardware, a method or process, or computer software on a computer-accessible medium.

The devices, system, and techniques described herein may provide one or more of the following advantages. The silicone dispensers described herein provide low viscosity and low specific gravity mixtures that can be used for encapsulation of lithium-ion batteries. For example, the silicone dispensers described herein utilize one or more progressive cavity pumps that include one or more polymer stators that prevents or at least not significantly cause silicone curing during processing. The one or more polymer stators prevent or at least do not significantly cause the destruction of glass beads that, if destroyed, would inhibit the cure of silicone. The one or more polymer stators are constructed of the polymer that is sulfur free. The silicone dispensers described herein provide for recirculation of a first material mixture and a second material mixture that advantageously facilitates operational downtime with minimal material loss. The silicone dispensers described herein utilize one or more mass flow meters to monitor flow, density, and the specific gravity of one or more materials to facilitate precise delivery of mixed materials. Additionally, the silicone dispensers utilize a mix head that prevents shearing of the one or more materials.

The details of one or more implementations are set forth in the accompanying drawings and the description below. Other features, aspects and potential advantages will be apparent from the accompanying description and figures.

### DESCRIPTION OF DRAWINGS

FIG. 1 is a back view of schematic diagram of an example silicone dispenser.

FIG. 2 is a front view of the silicone dispenser of FIG. 1.

FIG. 3 is an example perspective internal view of an example tank of the silicone dispenser.

FIG. 4A is a perspective view of an example side of a silicone dispenser.

FIG. 4B is a cross sectional view of an example pump.

FIG. 5 is a perspective view of a mix head of a silicone dispenser.

FIG. 6 is another perspective view of the mix head of FIG. 5.

FIG. 7 is a perspective view of a nozzle.

FIG. 8 is an example method for operating a silicone dispenser.

FIG. 9 is another example method for operating a silicone dispenser.

FIG. 10 is another example method for operating a silicone dispenser.

FIG. 11 is another example method for operating a silicone dispenser.

FIG. 12 is a schematic diagram that shows an example of a computing device and a mobile computing device.

Like reference symbols in the various drawings indicate like elements.

### DETAILED DESCRIPTION

This disclosure relates to silicone dispensers, systems for dispensing silicone, and methods for dispensing silicone. The silicone dispensers, systems, and methods facilitate the processing of silicone that can be used in one or more batteries. For example, the silicone dispensers, systems, and methods facilitate the processing of one or more mixtures of liquids and glass beads. The dispensers, systems, and methods can prevent, resist, or not significantly cause the curing of silicone within the dispensers and systems while processing mixtures of liquids and glass beads.

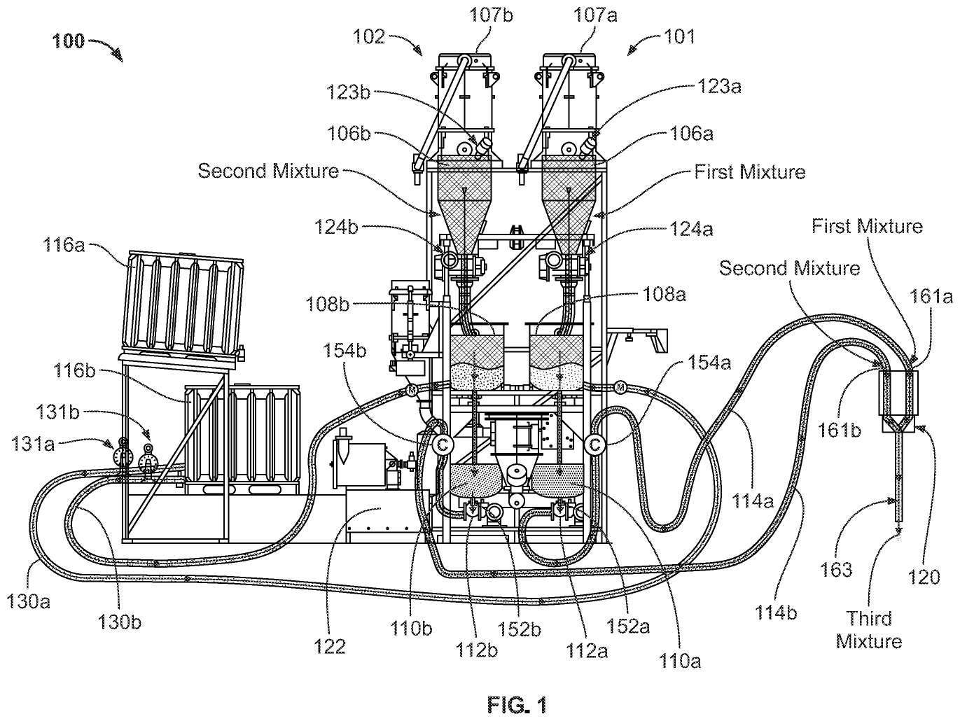

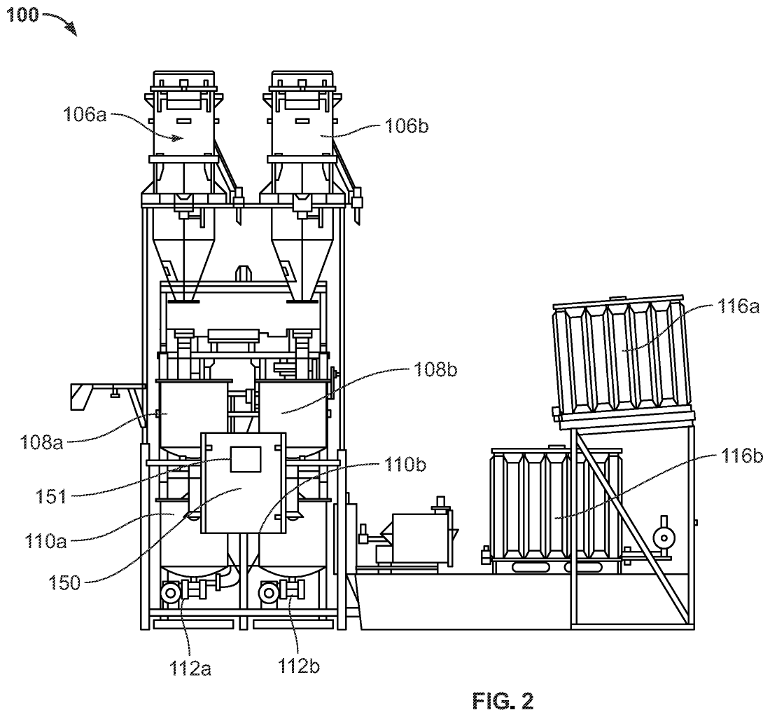

FIGS. 1 and 2 show an example silicone dispenser 100. The silicone dispenser 100 includes a first flow path 101 and a second flow path 102. The first flow path includes a first silo 106a, a first mixing tank 108a, a first holding tank 110a, a first pump 112a, and a first hose 114a. A first material supply tank 116a can be connected to the first mixing tank 108a. The second flow path 102 includes a second silo 106b, a second mixing tank 108b, a second holding tank 110b, a second pump 112b, and a second hose 114b. A second material supply tank 116b can be connected to the second mixing tank 108b. The first hose 114a and the second hose 114b can be connected to a mix head 120 that outputs a mixture of a first mixture and a second mixture. The silicone dispenser 100 can include a controller 150 (see e.g., FIG. 2) that has one or more processors and a computer-readable storage medium coupled to the one or more processors having instructions stored thereon which, when executed by the one or more processors, cause the one or more processors to perform operations, such as operations described herein.

The first silo 106a and the second silo 106b can each be configured for holding glass beads for mixture in the first mixing tank 108a and the second mixing tank 108b. The first silo 106a and the second silo 106b can each include vacuum receiver tanks 107a, 107b that can be connected to a vacuum pump 122 that supplies the glass beads to the first silo 106a and the second silo 106b. For example, the glass beads are pumped via the vacuum pump 122 into the first silo 106a and the second silo 106b until a silo level is full. The silo level is monitored by one or more silo level sensors 123a, 123b in each of the first silo 106a and the second silo 106b. Once the silo level is full, the first silo 106a and the second silo 106b meter the material (e.g., glass beads) into the first mixing tank 108a and the second mixing tank 108b. In some aspects, the silicone dispenser 100 can include a modular design where the first silo 106a and the second silo 106b are bypassed or not included. In some aspects, the silicone dispenser 100 can have a modular design where the first mix tank 108a and the second mix tank 108b along with the first silo 106a and the second silo 106b are omitted.

The first silo 106a and the second silo 106b can each include a valve 124a, 124b between the first silo 106a and the first mixing tank 108a and the second silo 106b and the second mixing tank 108b. In some aspects, the valves 124a, 124b can each be butterfly valves that include vibrating discs. For example, the valve 124a can be a butterfly valve that has a vibrating disc that includes a vibrator that causes linear vibration of the disc to swing the disc horizontally. The frequency of the vibration can be controlled via an electric analog signal and actuator that will open or close the valve to allow a range of flows. In some aspects, the valves 124a, 124b can be resilient seated wafer type butterfly valves with a vibration function that include a one piece disc and shaft. The valves 124a, 124b can be used for dosing the glass beads from the first silo 106a and the second silo 106b into the first mixing tank 108a and the second mixing tank 108b.

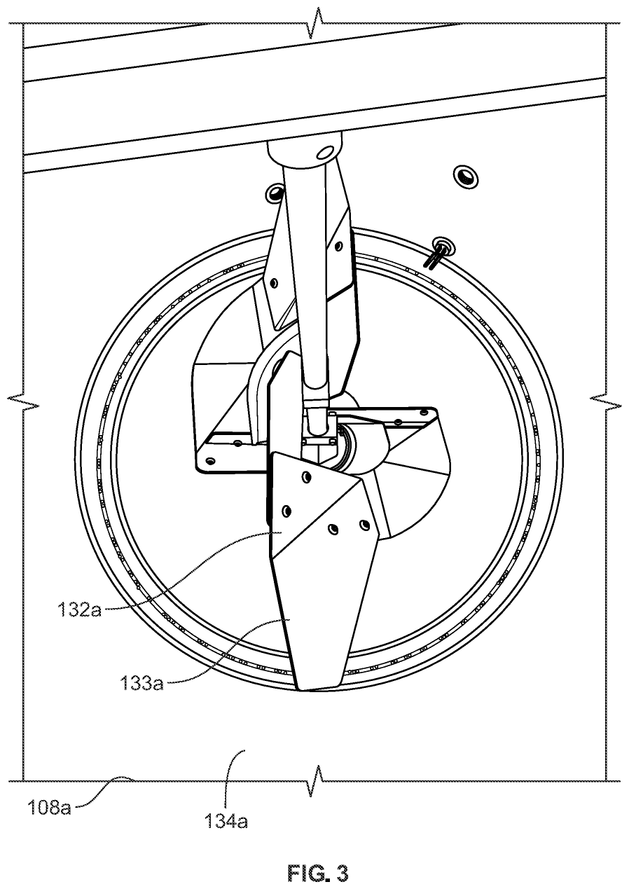

The first mixing tank 108a can be connected to the first silo 106a that provides glass beads to the first mixing tank 108a and connected to the first material supply tank 116a. The first mixing tank 108a is configured to hold a first liquid supplied by the first material supply tank 116a via a hose 130a and a pump 131a and a first quantity of glass beads. The first mixing tank 108a includes a first agitator 132a (see e.g., FIG. 3) that includes one or more blades that are rotatable to mix the first quantity of glass beads and the first liquid in the first mixing tank 108a.

The second mixing tank 108b can be connected to the second silo 106b that provides glass beads to the second mixing tank 108b and connected to the second material supply tank 116b. The second mixing tank 108b is configured to hold a second liquid supplied by the second material supply tank 116b via a hose 130b and a second quantity of glass beads. The second mixing tank 108b includes a second agitator (similar to first agitator 132a) that includes one or more blades that are rotatable to mix the second quantity of glass beads and the second liquid in the second mixing tank 108b. The second liquid has a different composition than that of the first liquid.

In some aspects, as illustrated in FIG. 3, the first agitator 132a can have one or more blades 133a that extend nearly into contact with an internal wall 134a of the first mixing tank 108a. For example, the blades 133a can extend to within one inch, within one half inch, or within one quarter inch from the wall 134a of the first tank 108a. For example, the first mixing tank 108a can have blades 133a that are long enough to extend near an interior wall of the first mixing tank 108a so as to suitably mix all or substantially all of the glass beads in the silicone, yet the blades 133a can be spaced far enough from the interior wall of the first mixing tank 108a so as to avoid grinding against the interior wall. While the first agitator 132a and the first tank 108a are discussed, the second agitator and the second tank 108b can share the same or similar features.

In some aspects, the first material and the second material can be mixed with glass beads and then together by the silicone dispenser 100 to form a silicone foam. In some aspects, the first material and the second material are each part of an addition cure silicone foam. In some aspects, the first material and the second material can each be a respective part of a two-part, addition cure, platinum catalyzed, silicone elastomeric, syntactic foam. The first material and the second material are designed as low density foams that can be used in electronics potting and as an encapsulation material. A third mixture that includes the first material with glass beads and the second material with glass beads form a solid foam after being mixed, while the first material and the second material are in liquid form throughout the silicone dispenser 100. The silicone dispenser 100 avoids the addition of an amount of sulfur in the third mixture that will cause the third mixture to remain in a liquid state and will not become a solid foam.

In some aspects, a third mixture including a first mixture of the first material with glass beads and a second mixture with the second material with glass beads can be biphasic, low viscosity materials. As separation can occur, the first mixture and second mixture should be well mixed prior to use to fully pre-disperse the material. Reincorporation of the third mixture should use a low shear methodology to ensure minimum stress on the filler medium. After the first material and second material have been rehomogenized, the silicone dispenser system 100 mixes the first mixture and the second mixture together with a low shear methodology. In some aspects, the first material and the second material can have a 1:1 mix ratio, by weight. Table 1 below provides non-limiting examples of the first and second materials and their respective properties.

TABLE 1

| Character | Unit | |
|---|---|---|
| Appearance | | 3250 A/B |
| | | Biphasic, White |
| | | Paste/Colorless to |
| | | Amber Liquid |
| Viscosity, First Material | cps | 1150 |
| Specific Gravity, First Material | | 0.66 |
| Viscosity, Second Material | cps | 800 |
| Specific Gravity, Second Material | | 0.66 |
| Duromotor | Shore OO | 50 |
| Cure Time (Snap back) | seconds | 275 |

Table 2 below provides non-limiting examples of the first and second materials and their respective properties.

| Character | Unit | |
|---|---|---|
| Appearance | | 3675 A/B |
| | | Biphasic, White |
| | | Paste/Colorless to |
| | | Amber Liquid |
| Viscosity, First Material | cps | 3300 |
| Specific Gravity, First Material | | 0.60 |
| Viscosity, Second Material | cps | 2100 |
| Specific Gravity, Second Material | | 0.60 |
| Duromotor | Shore OO | 65 |
| Cure Time (Snap back) | seconds | 220 |

In some aspects, the controller 150 and the one or more processors 151 can control the silicone dispenser 100 to provide the first material to the first mixing tank 108a and provide the second material to the second mixing tank 108b, fill the first silo 106a and the second silo 106b with glass beads, meter the glass beads into the first mixing tank 108a and the second mixing tank 108b (e.g., by weight), mix the first mixture in the first tank and the second mixture in the second tank for a minimum amount of time (e.g., 30 minutes), and release the first mixture into the first holding tank 110a and the second mixture into the second holding tank 110b.

The first holding tank 110a and the second holding tank 110b are connected to the first mixing tank 108a and the second mixing tank 108b, respectively. The first holding tank 110a can hold the first mixture and the second holding tank 110b can hold the second mixture. For example, the silicone dispenser 100 can complete mixing of the first mixture and the second mixture in the first mixing tank 108a and the second mixing tank 108b, and the silicone dispenser 100 can release the first mixture to the first holding tank 110a and the second mixture to the second holding tank 110b so that the first mixing tank 108a and the second mixing tank 108b can be utilized for additional mixing of materials.

The first flow path 101 can include a first level sensor 152a between the first holding tank 110a and the first pump 112a, and the second flow path 102 can include a second level sensor 152b between the second holding tank 110b and the second pump 112b. The first level sensor 152a and the second level sensor 152b can prevent the first pump 112a and the second pump 112b from being operated dry/without material.

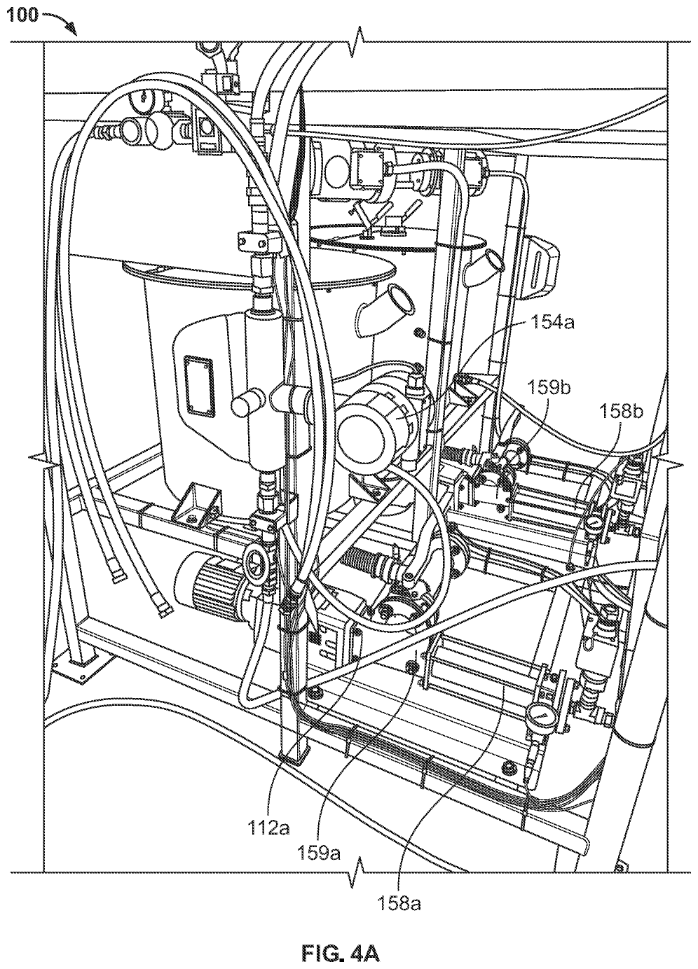

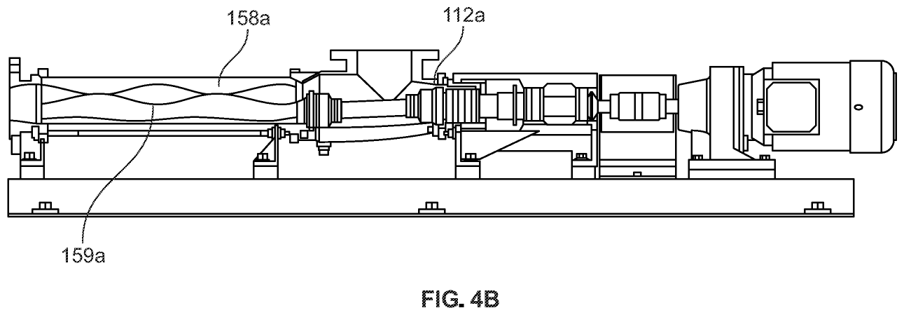

The first pump 112a can be a positive displacement pump that has a first stator 158a and a first rotor 159a (see e.g., FIGS. 4A and 4B). The first stator 158a comprises a polymer configured to avoid the inhibition or prevention of curing silicone. The second pump 112b can be a positive displacement pump that has a second stator 158b and a second rotor 159b. The second stator 158b can include the polymer configured to avoid the inhibition or prevention of curing silicone. The first and second polymer stators 158a, 158b each define an inner surface defining a flow path, and the polymer configured to avoid the inhibition or prevention of curing silicone is positioned on at least the inner surface of the first and second polymer stators 158a, 158b. In some aspects, the first and second polymer stators 158a, 158b include hydrogenated acrylonitrile butadiene rubber (HNBR), the HNBR is positioned on at least the inner surface of the first and second polymer stators. The inner surfaces of the first and second stators include no sulfur. In some aspects, the first rotor and the second rotor 159a, 159b can be metal rotors. Sulfur can inhibit the curing of platinum based silicone foams. The silicone dispenser 100 avoids the addition of an amount of sulfur in the third mixture that will cause the third mixture to remain in a liquid state and will not become a solid foam.

As shown in FIG. 4B, the first rotor 159a can have a helical shape that turns inside the stator 158a to progressively convey a consistently accurate volume of fluid through opening and closing cavities. The first stator 158a can also have a helical shape (on the inside) to also assist in progressively conveying a consistent accurate volume of fluid through opening and closing cavities. The first rotor 159a and the first stator 158a can be made of materials that do not contain sulfur, such as one or more non-sulfuric metals and HNBR.

In some aspects, the silicone dispenser 100 includes a first mass flow meter 154a connected to an outlet of the first pump 112a, the first mass flow meter 154a is configured to measure the mass flow rate of the first material downstream of the first pump 112a. The silicone dispenser includes a second mass flow meter 154b connected to an outlet of the second pump 112b, the second mass flow meter 154b is configured to measure the mass flow rate of the second material downstream of the second pump 112b. The first and second mass flow meters 154a, 154b can measure flow, density, and temperature of the first and second mixtures in the first flow path 101 and the second flow path 102. In some aspects, the first and second mass flow meters 154a, 154b are Coriolis meters. (see e.g., FIG. 4). The first mass flow meter 154a can monitor a specific gravity of the first mixture and the second mass flow meter 154b can monitor a specific gravity of the second mixture. In some aspects, the first mass flow meter 154a and the second mass flow meter 154b monitor a flow rate and a mixing ratio of the first material and the second material so that the mix ratio is a 1:1 mix ratio by volume. The mix ratio can have a tolerance of plus or minus 5% that can be an adjustable range limit that can go up to 10%.

The silicone dispenser 100 can monitor a first specific gravity of the first mixture via the first mass flow meter 154a and can monitor a second specific gravity of the second mixture via the second mass flow meter 154b. The silicone dispenser 100 via the controller 150 and the one or more processors 151 can determine if the first specific gravity and the second specific gravity are within a target specific gravity range. In some aspects, the target specific gravity range for the first mixture and the second mixture is a specific gravity between 0.6 and 0.7. If the specific gravity of both the first mixture and the second mixture are within the target range, the silicone dispenser 100 may allow the mix head 120 to dispense material.

The at least one first hose 114a and at least one second hose 114b can connect the first pump 112a and the second pump 112b to the mix head 120. The mix head 120 performs the mixing of the first mixture with the second mixture to form a third mixture. The first mixture can include the first material (such as the first material in Tables 1 and 2) and a first quantity of glass beads. The second mixture can include the second material (such as the second material in Tables 1 and 2) and a second quantity of glass beads. The third mixture can be a mixture of the first mixture and the second mixture at a 1:1 ratio of the first mixture and the second mixture.

The mix head 120 includes a first mix head inlet 161a in communication with the first pump 112a, a second mix head inlet 161b in communication with the second pump 112b, and a mixing nozzle 163 in fluid communication with the first inlet 161a and the second inlet 161b. The mixing nozzle 163 is configured to mix the first mixture and the second mixture and output the third mixture. In some aspects, the third mixture is a silicone foam.

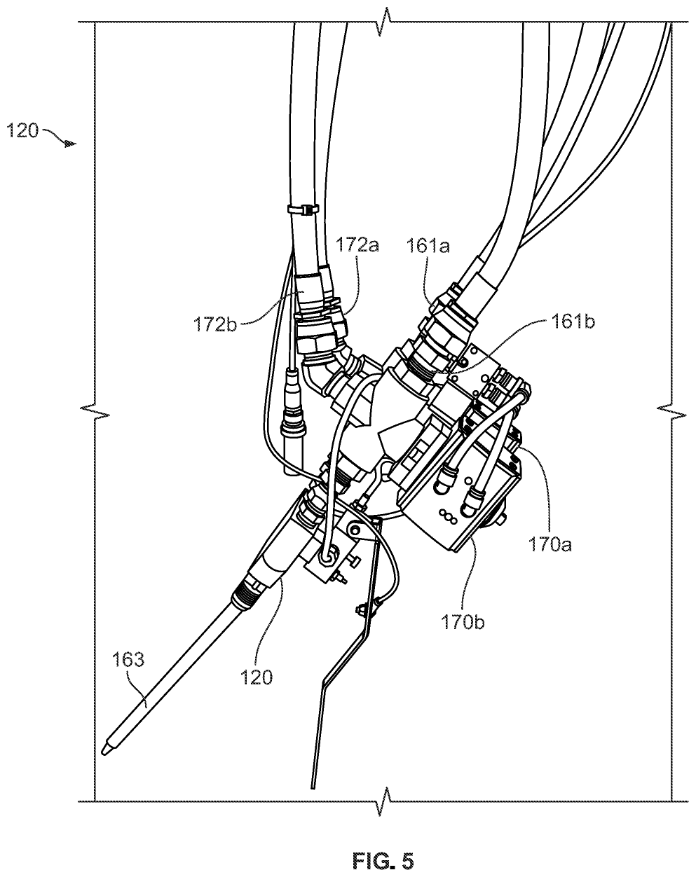

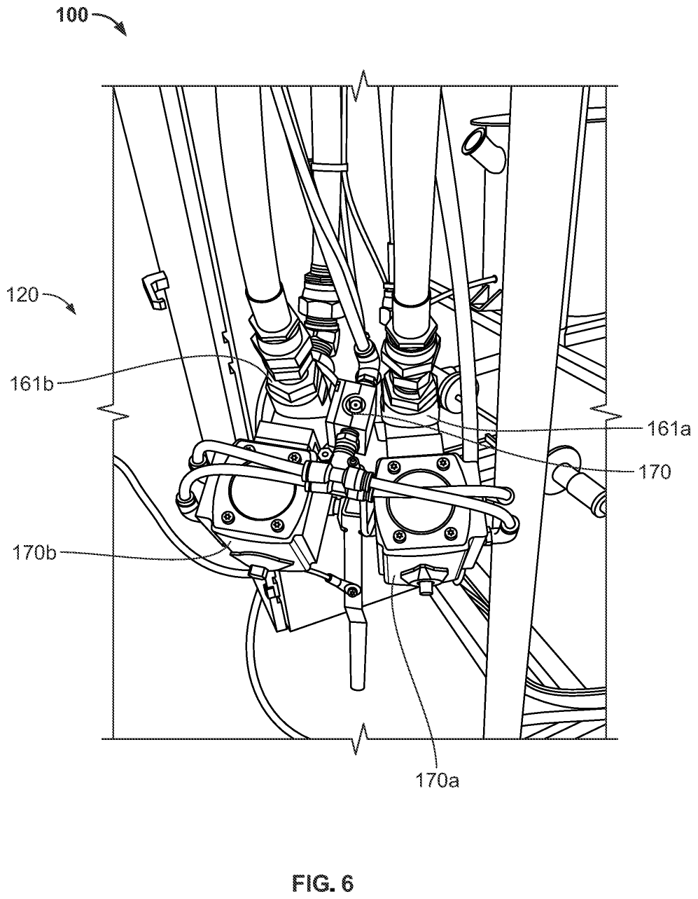

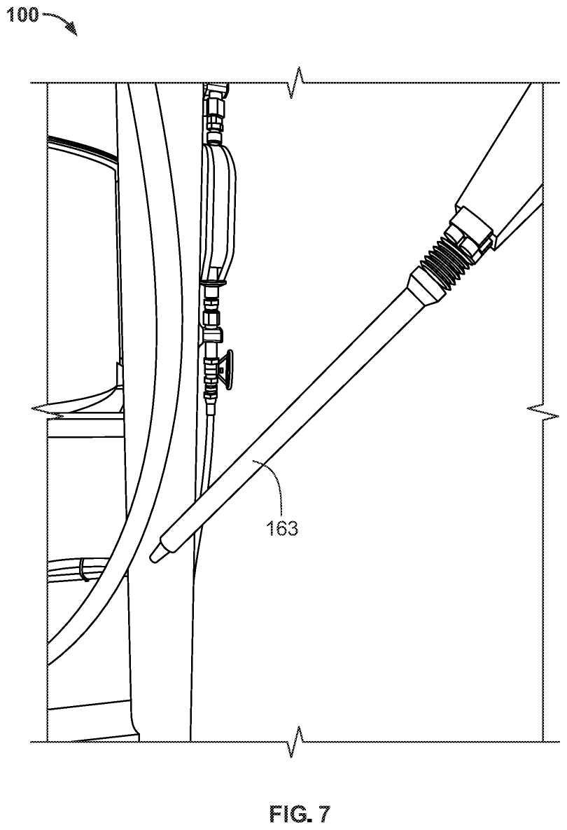

As shown in FIGS. 5-7, the mix head 120 includes a solenoid 170 that controls a first valve 170a connected to the first mix head inlet 161a and a second valve 170b connected to the second mix head inlet 161b. The first valve 170a can be a three-way valve that selectively facilitates fluid communication between the first pump 112a and the mixing nozzle 163, the second valve 170b can be a three-way valve that selectively facilitates fluid communication between the second pump 112b and the mixing nozzle 163.

In some aspects, the mix head 120 is connected to a first flow path that includes the first mixing tank 108a, the first holding tank 110a, the first pump 112a, the first mix head inlet 161a, the first hose 114a that extends from the first pump 112a to the first mix head inlet 161a. The first fluid path between the first pump 112a and the first mix head inlet 161a is free of turns at an angle of 90 degrees or less.

In some aspects, the mix head 120 is connected to a second flow path that includes the second mixing tank 108b, the second holding tank 110b, the second pump 112b, the second mix head inlet 161b, the second hose 114b that extends from the second pump 112b to the second mix head inlet 161b. The second fluid path between the second pump 112b and the second mix head inlet 161b is free of turns at an angle of 90 degrees or less. The first flow path and the second flow path provide a means to reduce shear in the first material and the second material.

In some aspects, a third flow path includes the mixing nozzle 163 that is connected to the first mix head inlet 161a and the second mix head inlet 161b. The mixing nozzle 163 is configured to mix the first material and the second material and output a third material that is a mixture comprising the first material and the second material.

The first valve 170a can be positioned in the first flow path and the second valve 170b can be positioned in the second flow path. The first valve 170a is connected to the first mix head inlet 161a, the first valve 170a selectively facilitates fluid communication between the first flow path and the third flow path. The second valve 170b is connected to the second mix head inlet 161b, the second valve selectively facilitates fluid communication between the second flow path and the third flow path.

In some aspects, a fourth flow path includes a first circulation outlet 172a in fluid communication with the first mix head inlet 161a and the first mixing tank 108a. The fourth fluid path between the first mix head inlet 161a and the first tank 108a is free of turns at an angle of 90 degrees or less.

In some aspects, a fifth flow path includes a second circulation outlet 172b in fluid communication with the second mix head inlet 161b and the second mixing tank 108b. The fifth fluid path between the second mix head inlet 161b and the second tank 108b is free of turns at an angle of 90 degrees or less.

The first valve 170a can be positioned in the first flow path and the first valve 170a is connected to the first mix head inlet 161a, the first valve 170a having an open position that facilitates fluid communication between the first flow path and the third flow path. The first valve 170a also has a circulation position that facilitates communication between the first flow path and the fourth flow path (e.g., facilitates flow from the first mix head inlet 161a to the first circulation outlet 172a).

The second valve 170b can be positioned in the second flow path. The second valve 170b can have an open position that facilitates fluid communication between the second flow path and the third flow path. The second valve 170b also has a circulation position that facilitates communication between the second flow path and the fifth flow path (e.g., facilitates flow from the second mix head inlet 161b to the second circulation outlet 172b).

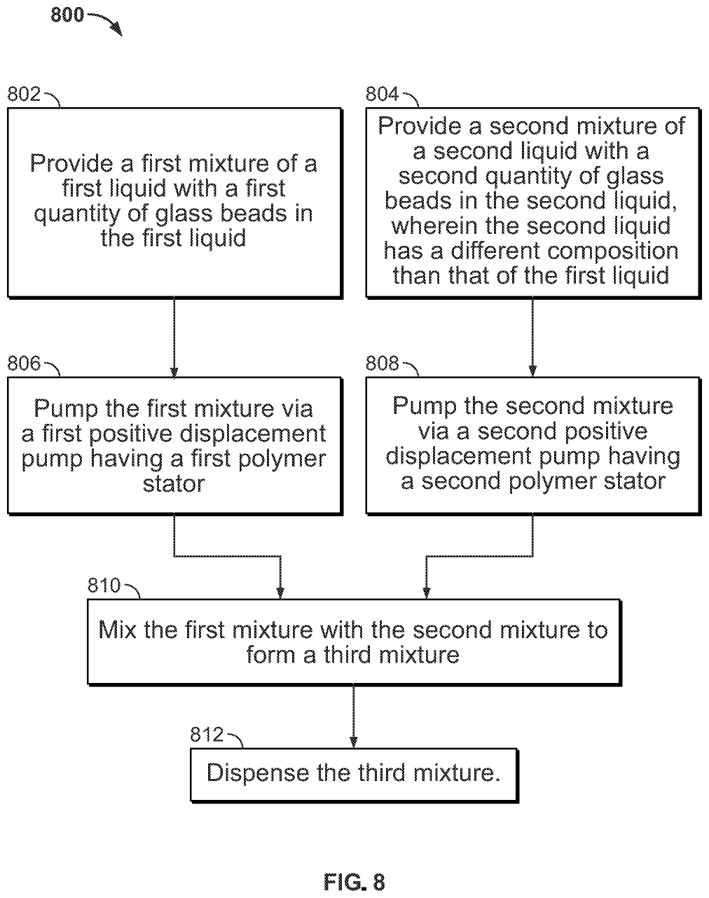

FIG. 8 illustrates an exemplary method 800 for operating a silicone dispenser, such as for example the silicone dispenser 100. The method 800 includes step 802 of providing a first mixture of a first liquid with a first quantity of glass beads in the first liquid. The method 800 includes step 804 of providing a second mixture of a second liquid with a second quantity of glass beads in the second liquid, wherein the second liquid has a different composition than that of the first liquid. The method 800 includes step 806 of pumping the first mixture via a first positive displacement pump having a first polymer stator (such as a stator having a polymer containing no sulfur on at least a contact surface of the stator, such as a stator having HNBR material containing no sulfur). The method 800 includes step 808 of pumping the second mixture via a second positive displacement pump having a second polymer stator (such as a stator having a polymer containing no sulfur on at least a contact surface of the stator, such as a stator having HNBR material containing no sulfur). The method 800 includes step 810 of mixing the first mixture with the second mixture to form a third mixture. The method 800 includes step 812 of dispensing the third mixture.

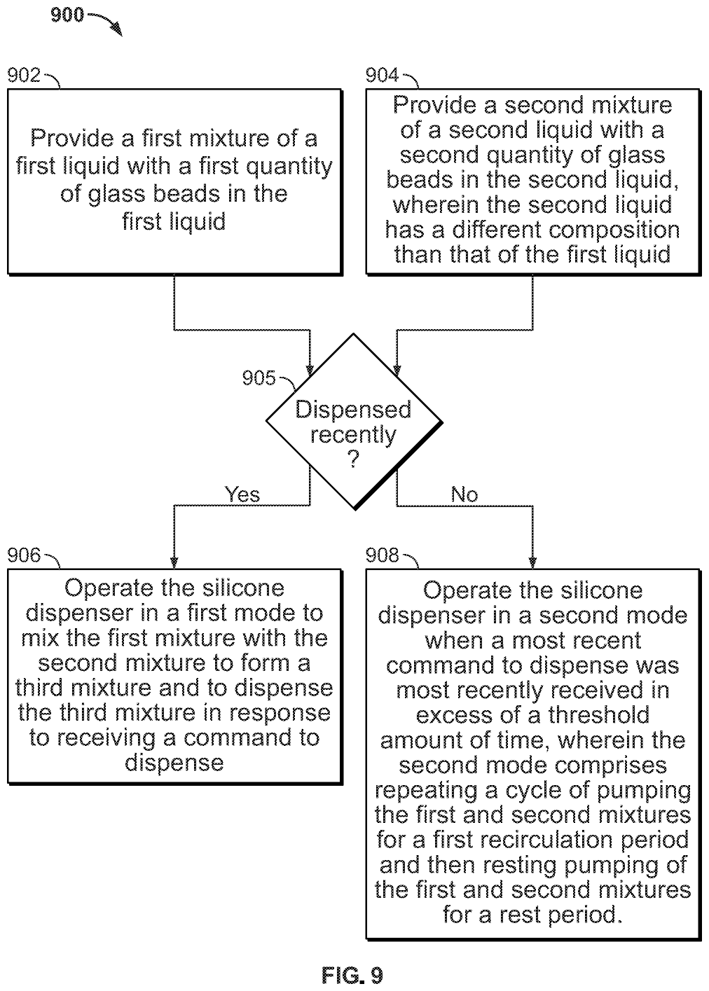

FIG. 9 illustrates an exemplary method 900 for operating a silicone dispenser, such as for example the silicone dispenser 100. The method 900 includes step 902 of providing a first mixture of a first liquid with a first quantity of glass beads in the first liquid. The method 900 includes step 904 of providing a second mixture of a second liquid with a second quantity of glass beads in the second liquid, wherein the second liquid has a different composition than that of the first liquid. The method 900 includes a decision block 905 to determine whether the silicone dispenser has dispensed recently. For example, the decision block 905 can determine whether a most recent command to dispense was most recently received in excess of a threshold amount of time, such as within 10 minutes. If yes, the method 900 can go to step 906. If no, the method 900 can go to step 908. The method 900 includes step 906 of operating the silicone dispenser in a first mode to mix the first mixture with the second mixture to form a third mixture and to dispense the third mixture in response to receiving a command to dispense. The method 900 includes step 908 of operating the silicone dispenser in a second mode when a most recent command to dispense was most recently received in excess of a threshold amount of time. The second mode includes repeating a cycle of pumping the first and second mixtures for a first recirculation period and then resting pumping of the first and second mixtures for a rest period. The agitators (e.g., agitators 132a, 132b) can continue to run during the rest period and in the second mode.

The method 900 can also include operating the silicone dispenser in a third mode in response to receiving a command to dispense during the second mode. In the third mode the silicone dispenser can restrict or prevent dispensing of the third mixture until the first and second mixtures have been recirculated for a second recirculation period. In the third mode the silicone dispenser can restrict or prevent dispensing of the third mixture until the specific gravity of the first mixture and the specific gravity of the second mixture are within a target specific gravity range. In some aspects, the target specific gravity range is between 0.6 and 0.7.

In some aspects, the rest period is longer than the first recirculation period. The first recirculation period can be longer than an amount of time required to circulate substantially all of the first and second mixtures located in first and second hoses to flow into first and second tanks, respectively. The resting period can be between 15 minutes and 60 minutes, and the first recirculation period can be between 1 minute and 10 minutes.

In some aspects, the silicone dispenser restricts or prevents operation of first and second dispensing valves when the most recent command to dispense was most recently received in excess of the threshold amount of time. The silicone dispenser includes a first flow path for recirculating the first mixture and a second flow path for recirculating the second mixture, wherein the first flow path comprises a first hose and a first positive displacement pump, wherein the second flow path comprises a second hose and a second positive displacement pump, the first and second positive displacement pumps are not operated during the resting period. The silicone dispenser comprises a mixer, wherein the first and second flow paths are configured to bypass the mixer during the first recirculation period.

In some aspects, a controller comprising one or more processors and a computer-readable storage medium coupled to the one or more processors having instructions stored thereon which, when executed by the one or more processors, cause the one or more processors to perform operations. The operations can include: track an amount of time since a most recent dispensing operation, determine when the amount of time is in excess of a threshold amount of time; actuate a solenoid into a circulation position to close the outlet and open the first circulation outlet and the second circulation outlet; track a circulation time that the solenoid is in the circulation position; determine when the circulation time is in excess of a circulation threshold; actuate the solenoid to a closed position where the outlet is closed.

The controller 150 and the one or more processors 151 and a computer-readable storage medium coupled to the one or more processors 151 having instructions stored thereon which, when executed by the one or more processors 151, cause the one or more processors 151 to perform operations. The operations can include: monitor a first specific gravity of the first mixture via the first mass flow meter 154a; monitor a second specific gravity of the second mixture via the second mass flow meter 154b; determine if the first specific gravity and the second specific gravity are within a target specific gravity range; and operate the silicone dispenser 100 in a first mode to mix the first mixture with the second mixture to form a third mixture and to dispense the third mixture in response to receiving a command to dispense.

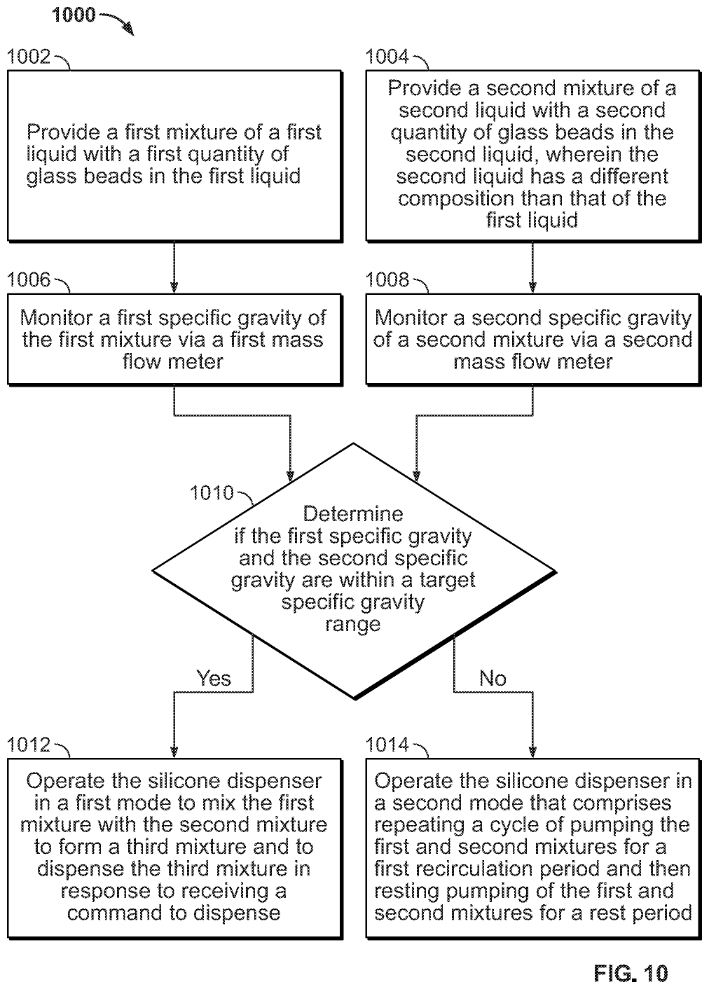

FIG. 10 illustrates an exemplary method 1000 for operating a silicone dispenser, such as for example the silicone dispenser 100. The method 1000 includes the step 1002 of providing a first mixture of a first liquid with a first quantity of glass beads in the first liquid. The method 1000 includes the step 1004 of providing a second mixture of a second liquid with a second quantity of glass beads in the second liquid, wherein the second liquid has a different composition than that of the first liquid. The method 1000 includes the step 1006 of monitoring a first specific gravity of the first mixture via a first mass flow meter. The method 1000 includes the step 1008 of monitoring a second specific gravity of a second mixture via a second mass flow meter. The method 1000 includes the step 1010 of determining if the first specific gravity and the second specific gravity are within a target specific gravity range. The method 1000 includes the step 1012 of operating the silicone dispenser in a first mode to mix the first mixture with the second mixture to form a third mixture and to dispense the third mixture in response to receiving a command to dispense. The method 1000 includes the step 1014 of operating the silicone dispenser in a second mode when at least one of the first specific gravity and the second specific gravity are outside of the target specific gravity range, wherein the second mode comprises repeating a cycle of pumping the first and second mixtures for a first recirculation period and then resting pumping of the first and second mixtures for a rest period.

In some aspects, the method 1000 further includes a step of operating the silicone dispenser in a third mode in response to receiving a command to dispense during the second mode, wherein in the third mode the silicone dispenser restricts or prevents dispensing of the third mixture until the specific gravity of the first mixture and the specific gravity of the second mixture are within the target specific gravity range.

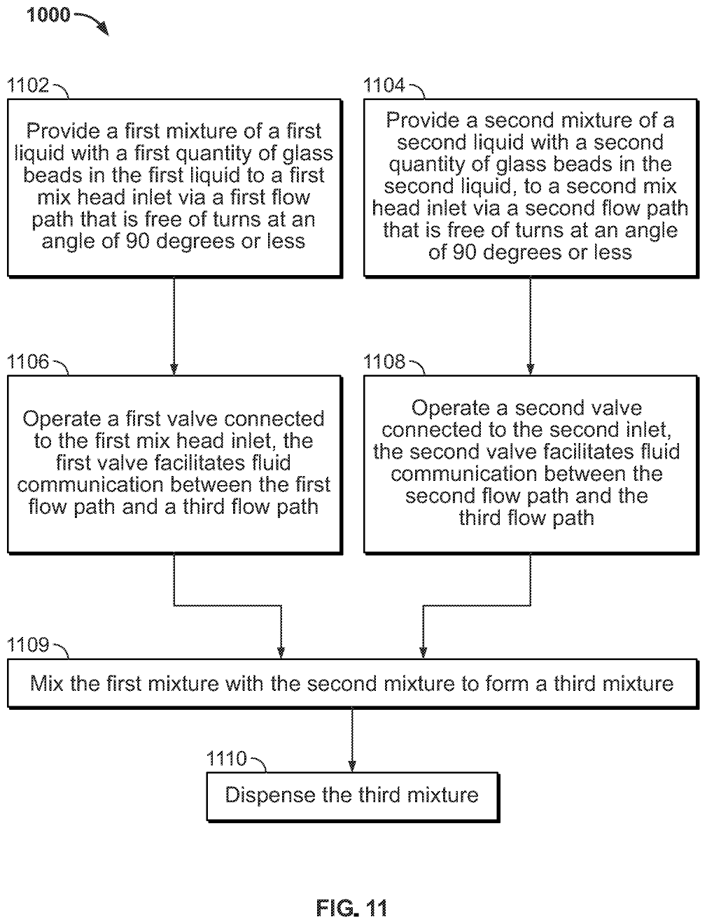

FIG. 11 shows an exemplary method 1100 for operating a silicone dispenser, such as for example the silicone dispenser 100. The method 1100 includes the step 1102 of providing a first mixture of a first liquid with a first quantity of glass beads in the first liquid to a first mix head inlet via a first flow path that is free of turns at an angle of 90 degrees or less. The method 1100 includes the step 1104 of providing a second mixture of a second liquid with a second quantity of glass beads in the second liquid, to a second mix head inlet via a second flow path that is free of turns at an angle of 90 degrees or less. The method 1100 includes the step 1106 of operating a first valve connected to the first mix head inlet, the first valve facilitates fluid communication between the first flow path and a third flow path. The method 1100 includes the step 1108 of operating a second valve connected to the second inlet, the second valve facilitates fluid communication between the second flow path and the third flow path. The method 1100 includes the step 1109 of mixing the first mixture with the second mixture to form a third mixture. The method 1100 includes the step 1110 of dispensing the third mixture.

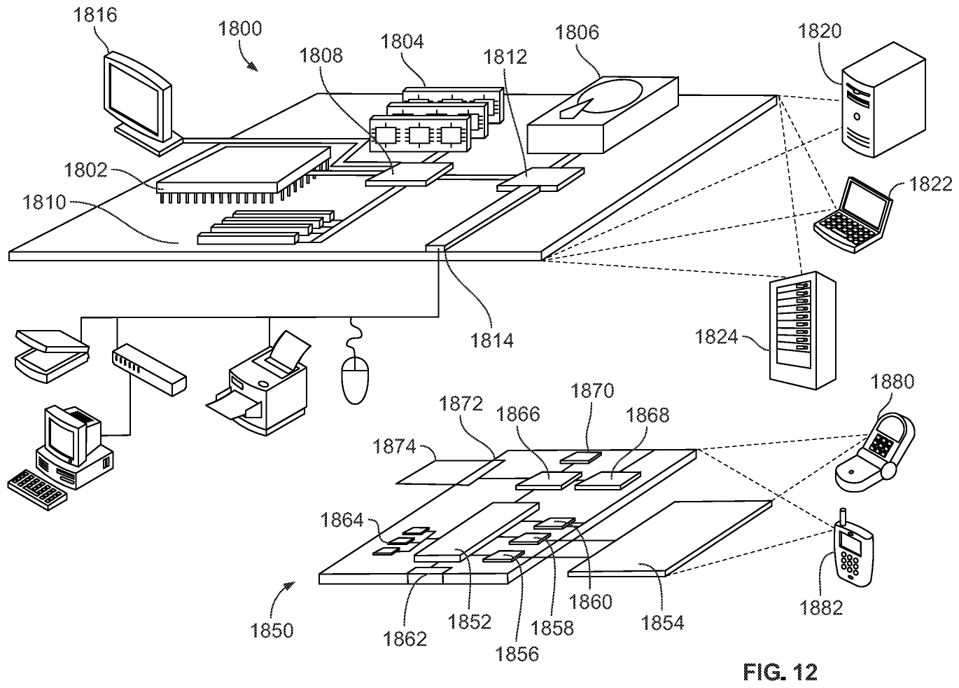

FIG. 12 shows an example of a computing device 1800 and an example of a mobile computing device that can be used to implement the techniques described here. In some embodiments, the controller 150 can include one, some, or all of the features described with respect to the computing device 1800. The computing device 1800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and can be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system). The memory 1804 stores information within the computing device 1800. In some implementations, the memory 1804 is a volatile memory unit or units. In some implementations, the memory 1804 is a non-volatile memory unit or units. The memory 1804 can also be another form of computer-readable medium, such as a magnetic or optical disk. The storage device 1806 is capable of providing mass storage for the computing device 1800. In some implementations, the storage device 1806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1804, the storage device 1806, or memory on the processor 1802.

The high-speed interface 1808 manages bandwidth-intensive operations for the computing device 1800, while the low-speed interface 1812 manages lower bandwidth-intensive operations. Such allocation of functions is exemplary only. In some implementations, the high-speed interface 1808 is coupled to the memory 1804, the display 1816 (e.g., through a graphics processor or accelerator), and to the high-speed expansion ports 1810, which can accept various expansion cards (not shown). In the implementation, the low-speed interface 1812 is coupled to the storage device 1806 and the low-speed expansion port 1814. The low-speed expansion port 1814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. The computing device 1800 can be implemented in a number of different forms, as shown in the figure. For example, it can be implemented as a standard server 1820, or multiple times in a group of such servers. In addition, it can be implemented in a personal computer such as a laptop computer 1822. It can also be implemented as part of a rack server system 1824. Alternatively, components from the computing device 1800 can be combined with other components in a mobile device (not shown), such as a mobile computing device 1850. Each of such devices can contain one or more of the computing device 1800 and the mobile computing device 1850, and an entire system can be made up of multiple computing devices communicating with each other. The mobile computing device 1850 includes a processor 1852, a memory 1864, an input/output device such as a display 1854, a communication interface 1866, and a transceiver 1868, among other components. The mobile computing device 1850 can also be provided with a storage device, such as a micro-drive or other device, to provide additional storage. Each of the processor 1852, the memory 1864, the display 1854, the communication interface 1866, and the transceiver 1868, are interconnected using various buses, and several of the components can be mounted on a common motherboard or in other manners as appropriate.

The processor 1852 can execute instructions within the mobile computing device 1850, including instructions stored in the memory 1864. The processor 1852 can be implemented as a chipset of chips that include separate and multiple analog and digital processors. The processor 1852 can provide, for example, for coordination of the other components of the mobile computing device 1850, such as control of user interfaces, applications run by the mobile computing device 1850, and wireless communication by the mobile computing device 1850. The processor 1852 can communicate with a user through a control interface 1858 and a display interface 1856 coupled to the display 1854. The display 1854 can be, for example, a TFT (Thin-Film-Transistor Liquid Crystal Display) display or an OLED (Organic Light Emitting Diode) display, or other appropriate display technology. The display interface 1856 can comprise appropriate circuitry for driving the display 1854 to present graphical and other information to a user. The control interface 1858 can receive commands from a user and convert them for submission to the processor 1852. In addition, an external interface 1862 can provide communication with the processor 1852, so as to enable near area communication of the mobile computing device 1850 with other devices. The external interface 1862 can provide, for example, for wired communication in some implementations, or for wireless communication in other implementations, and multiple interfaces can also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 can also be provided and connected to the mobile computing device 1850 through an expansion interface 1872, which can include, for example, a SIMM (Single In Line Memory Module) card interface. The expansion memory 1874 can provide extra storage space for the mobile computing device 1850, or can also store applications or other information for the mobile computing device 1850. Specifically, the expansion memory 1874 can include instructions to carry out or supplement the processes described above, and can include secure information also. Thus, for example, the expansion memory 1874 can be provide as a security module for the mobile computing device 1850, and can be programmed with instructions that permit secure use of the mobile computing device 1850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1864, the expansion memory 1874, or memory on the processor 1852. In some implementations, the computer program product can be received in a propagated signal, for example, over the transceiver 1868 or the external interface 1862.

The mobile computing device 1850 can communicate wirelessly through the communication interface 1866, which can include digital signal processing circuitry where necessary. The communication interface 1866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1868 using a radio-frequency. In addition, short-range communication can occur, such as using a Bluetooth, WiFi, or other such transceiver (not shown). In addition, a GPS (Global Positioning System) receiver module 1870 can provide additional navigation- and location-related wireless data to the mobile computing device 1850, which can be used as appropriate by applications running on the mobile computing device 1850. The mobile computing device 1850 can also communicate audibly using an audio codec 1860, which can receive spoken information from a user and convert it to usable digital information. The audio codec 1860 can likewise generate audible sound for a user, such as through a speaker, e.g., in a handset of the mobile computing device 1850. Such sound can include sound from voice telephone calls, can include recorded sound (e.g., voice messages, music files, etc.) and can also include sound generated by applications operating on the mobile computing device 1850. The mobile computing device 1850 can be implemented in a number of different forms, as shown in the figure. For example, it can be implemented as a cellular telephone 1880. It can also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. The computing system can include clients and servers. A client and server are generally remote from each other and typically interact through a communication network. The relationship of client and server arises by virtue of computer programs running on the respective computers and having a client-server relationship to each other.

A number of aspects/embodiments of the inventions have been described. Nevertheless, it will be understood that various modifications can be made without departing from the spirit and scope of the invention. For example, in some embodiments the silicone dispenser 100 can include components of different sizes, shapes, and orientations. Additionally, different features of different embodiments of the silicone dispenser described above can be combined with other features as suitable for the application. Accordingly, other embodiments are within the scope of the following claims.

What is claimed is:

1. A method of operating a silicone dispenser, the method comprising:
providing a first mixture of a first liquid with a first quantity of glass beads in the first liquid;
providing a second mixture of a second liquid with a second quantity of glass beads in the second liquid, wherein the second liquid has a different composition than that of the first liquid;
pumping the first mixture via a first positive displacement pump having a first polymer stator;
pumping the second mixture via a second positive displacement pump having a second polymer stator;
mixing the first mixture with the second mixture to form a third mixture; and
dispensing the third mixture.

2. The method of claim 1, wherein the first and second polymer stators each define an inner surface defining a flow path, wherein the first and second polymer stators comprise a polymer configured to avoid the inhibition or prevention of curing silicone, wherein the polymer configured to avoid the inhibition or prevention of curing silicone is positioned on at least the inner surface of the first and second polymer stators.

3. The method of claim 1, wherein the first and second polymer stators each define an inner surface defining a flow path, wherein the first and second polymer stators comprise HNBR, wherein the HNBR is positioned on at least the inner surface of the first and second polymer stators.

4. The method of claim 1, wherein inner surfaces of the first and second stators include no sulfur.

5. The method of claim 1, wherein a mix head performs the mixing of the first mixture with the second mixture, the mix head includes:
a first inlet in communication with the first positive displacement pump;
a second inlet in communication with the second positive displacement pump; and
a mixing nozzle in fluid communication with the first inlet and the second inlet that is configured to mix the first mixture and the second mixture and outputs the third mixture.

6. The method of claim 1, further comprising:
mixing the first liquid and the first quantity of glass beads in a first tank with a first agitator having one or more blades that extend to within one inch from an internal tank wall of the first tank; and
mixing the second liquid and the second quantity of glass beads in a second tank with a second agitator having one or more blades that extend to within one inch from an internal tank wall of the second tank.

7. The method of claim 1, wherein the first mixture comprises platinum.

8. The method of claim 1, further comprising monitoring a specific gravity of the first mixture and monitoring a specific gravity of the second mixture.

9. The method of claim 1, wherein the first mixture and the second mixture have a specific gravity between 0.6 and 0.7.

10. The method of claim 1, wherein the third mixture is a silicone foam.

11. A silicone dispenser comprising:
a first flow path comprising:
a first tank for holding a first liquid with a first quantity of glass beads in the first liquid;
a first positive displacement pump having a first stator and a first rotor, wherein the first stator comprises a polymer configured to avoid the inhibition or prevention of curing silicone;
at least one first hose; and
a second flow path comprising:
a second tank for holding a second liquid with a second quantity of glass beads in the second liquid;
a second positive displacement pump having a second stator and a second rotor, wherein the second stator comprises the polymer configured to avoid the inhibition or prevention of curing silicone;
at least one second hose.

12. The silicone dispenser of claim 11, wherein the polymer configured to avoid the inhibition or prevention of curing silicone is positioned on at least an inner surface of the first and second polymer stators.

13. The silicone dispenser of claim 11, wherein inner surfaces of the first and second stators include no sulfur.

14. The silicone dispenser of claim 11, wherein the first and second polymer stators each define an inner surface defining a flow path, wherein the first and second polymer stators comprise HNBR, wherein the HNBR is positioned on at least the inner surface of the first and second polymer stators.

15. The silicone dispenser of claim 11, wherein the first tank comprises an agitator having one or more blades that extend to within one inch from an internal tank wall of the first tank.

16. The silicone dispenser of claim 11, wherein the second tank comprises an agitator having one or more blades that extend to within one inch from an internal tank wall of the second tank.

17. The silicone dispenser of claim 11 further comprising:
a mix head that includes:
a first inlet in communication with the first positive displacement pump;
a second inlet in communication with the second positive displacement pump; and
a mixing nozzle in fluid communication with the first inlet and the second inlet that is configured to mix the first liquid and the second liquid and outputs a material mixture comprising the first material and the second material.

18. The silicone dispenser of claim 17, wherein the mix head includes:
a solenoid that has a first valve connected to the first inlet and a second valve connected to the second inlet, the first valve selectively facilitates fluid communication between the first positive displacement pump and the mixing nozzle, the second valve selectively facilitates fluid communication between the second positive displacement pump and the mixing nozzle.

19. The silicone dispenser of claim 17, wherein the first flow path comprises a first level sensor between the first tank and the first positive displacement pump, and the second flow path comprises a second level sensor between the second tank and the second positive displacement pump.

20. A system comprising:
a first tank configured for holding a first material comprising a first liquid with a first quantity of glass microspheres in the first liquid;
a second tank configured for holding a second material comprising a second glass microspheres in the second material;
a first progressive cavity pump in fluid communication downstream of the first tank, the first progressive cavity pump including a stator comprising HNBR material and a rotor; and
a second progressive cavity pump in fluid communication downstream of the second tank, the second progressive cavity pump including a second stator comprising HNBR material and a second rotor.
